(19) United States
(12) Patent Application Publication
(10) Pub. No.: US 2011/0068582 A1
(43) Pub. Date: Mar. 24, 2011

(54) MULTI-STACK FLYWHEEL WIND ASSEMBLY

(76) Inventor: Patrick J. Dugas, (US)

(21) Appl. No.: 12/563,666

(22) Filed: Sep. 21, 2009

(51) Int. Cl. F03D 9/02

(52) U.S. Cl. 290/55

(57) ABSTRACT

The present invention relates to a combination of flywheels or multi-stacked flywheels, ratchets or positive locking roller stops and speed activated clutches. The combinations allow the present invention to reduce the cut-in speed and reach rated speed sooner than existing technology, allowing the wind turbine to begin converting electricity sooner and reach rated capacity earlier to further improve the electrical generating output of the wind turbine. The multi-stacked flywheels of the present invention also capture excess energy above rated speed in small increments and store that energy to be released as the wind subsides allowing the wind turbine generator to maintain optimum speed longer and to continue to generate electricity for a period of time after the wind stops.

### TECHNICAL FIELD

This invention relates to flywheels, particularly multi-stacked flywheels for an energy capture and storage system that receives energy through wind power via a wind turbine.

### BACKGROUND OF THE INVENTION

A wind turbine is a rotary machine, which converts the kinetic energy in wind into mechanical energy. The mechanical energy is then converted into electricity. Cut-in speed is the minimum wind speed at which the wind turbine will generate usable power. The rated speed is the minimum wind speed at which the wind turbine will generate its designated rated power.

### SUMMARY OF THE INVENTION

The present invention is comprised of combinations of flywheels, multi-stacked flywheels, ratchets or positive locking roller stops and speed activated clutches. The combinations of the present invention allow wind turbines to reduce the cut-in speed and reach rated speed sooner, thereby generating electricity sooner and reach rated capacity earlier to further improve the electrical generating output of the wind turbine. The multi-stacked flywheels of the present invention also capture excess energy above rated speed in small increments and store that energy to be released as the wind subsides allowing the wind turbine to maintain optimum speed longer and to continue to generate electricity for a period of time after the wind stops.

### BRIEF DESCRIPTION OF THE DRAWINGS

FIG. 1 is a sectional view through the center of the shaft of the first part of the Multi Stacked Flywheel Wind Assembly (MSFWA) for a horizontal axis configuration with the main rotor shaft horizontal showing the initial sequencing of the present invention.

FIG. 1A is a sectional view through the center of the shaft of the first part of the MSFWA for a horizontal rotor shaft connected to a vertical flywheel shaft via a gearbox.

FIG. 1B is a sectional view through the center of the shaft of the first part of the MSFWA for a vertical only rotor shaft configuration.

FIG. 2 is a sectional view through the center of the shaft of the second part of the MSFWA showing the continuation of sequencing of the present invention for the horizontal axis configuration in FIG. 1.

FIG. 2A is a sectional view through the center of the shaft of the second part of the MSFWA showing the continuation of sequencing of the present invention for the vertical flywheel shaft configurations in FIG. 1A and FIG. 1B.

### DETAILED DESCRIPTION OF THE PREFERRED EMBODIMENTS

As shown in the figures, the MSFWA of the present invention is a sequence of various parts in combination to allow rotation of the shaft initiated by the wind turning the rotor 5 in a desired direction (clockwise in this case).

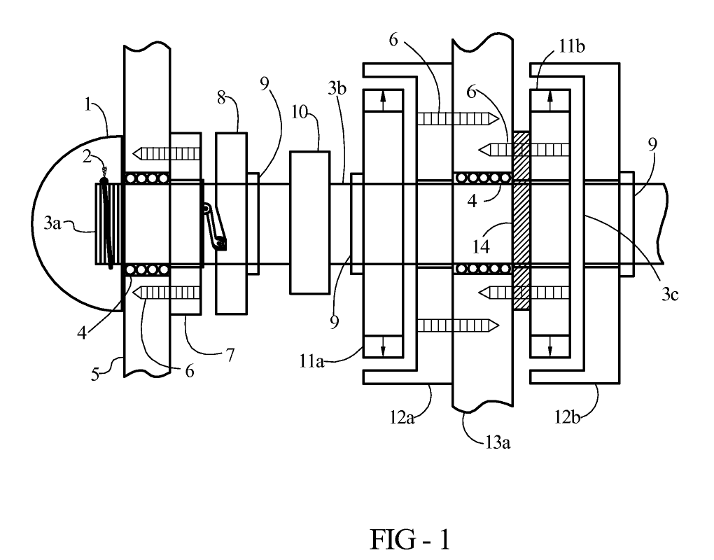

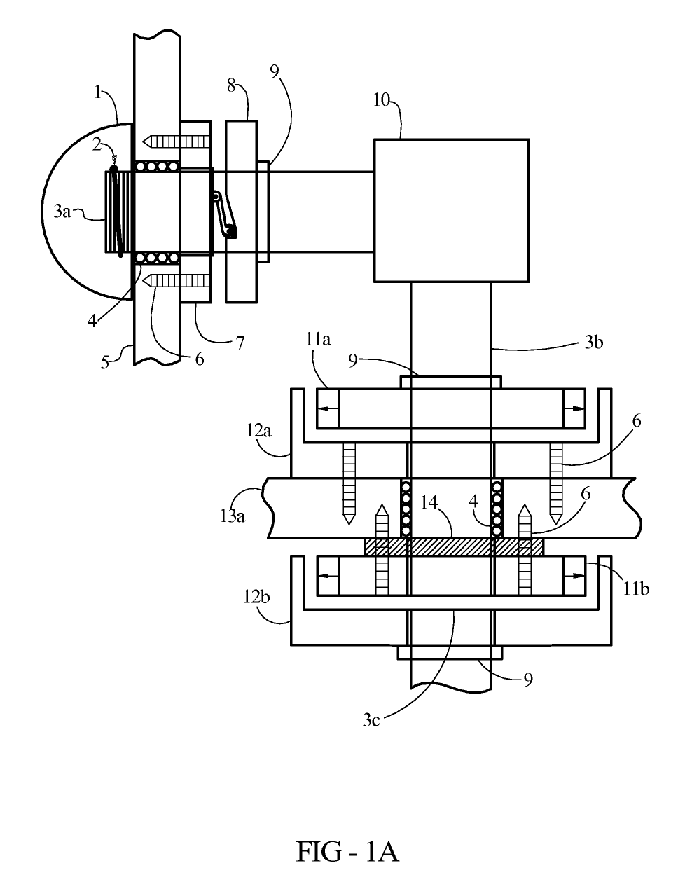

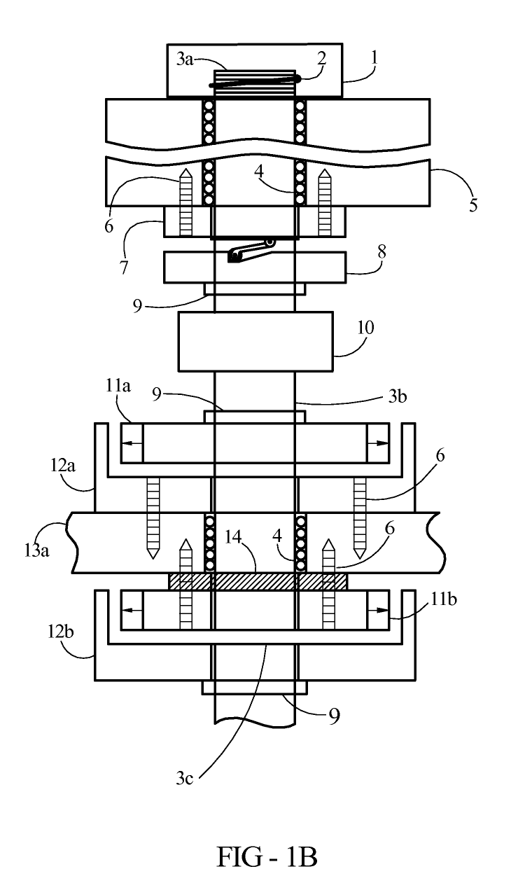

The MSFWA in FIG. 1 is comprised of a shaft 3a with threads and a lock pin 2 to attach the nose cone 1 in a desired position as to not interfere with the rotation of the rotor 5 on bearings 4 around shaft 3a. The spring arm side 7 of a Positive Locking Roller Stop (PLRS) is attached to the rotor 5 with fasteners 6 but not in contact with shaft 3a. The other side 8 of the PLRS is attached by locking flange 9 to shaft 3a to translate rotation from rotor 5. The PLRS allows rotation from rotor 5 to be transmitted to gearbox 10, but does not decrease rotational speed as rotor speed decreases. Shaft 3a is connected to gearbox 10 to increase the rotational speed of shaft 3b into Clutch assembly 11a/12a. The expanding inside part of Clutch 11a is attached to shaft 3b with locking flange 9. At a desired rotational speed, the inside expanding part 11a of the Clutch engages with part 12a which is fastened to Flywheel 13a with fasteners 6 but not attached to shaft 3b. The Flywheel 13a rotates freely around shaft 3b on bearing 4. A spacer 14, not in contact with shaft 3b separates flywheel 13a from the inside expanding part 11b of the next Clutch. Fasteners 6 connect 13a to 11b. At a desired rotational speed, the inside expanding part 11b of the next Clutch engages with part 12b which is fastened to shaft 3c with locking flange 9.

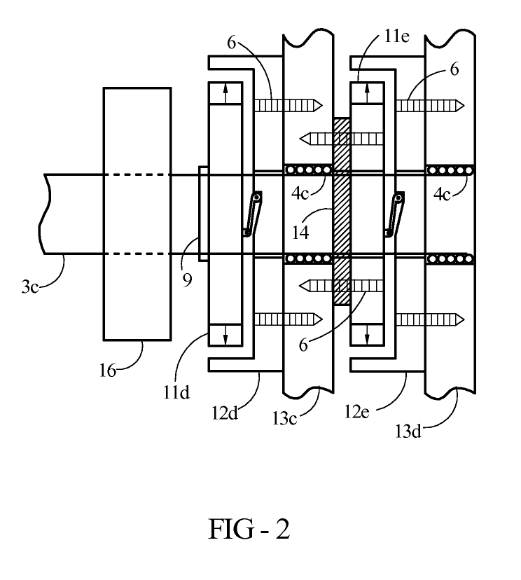

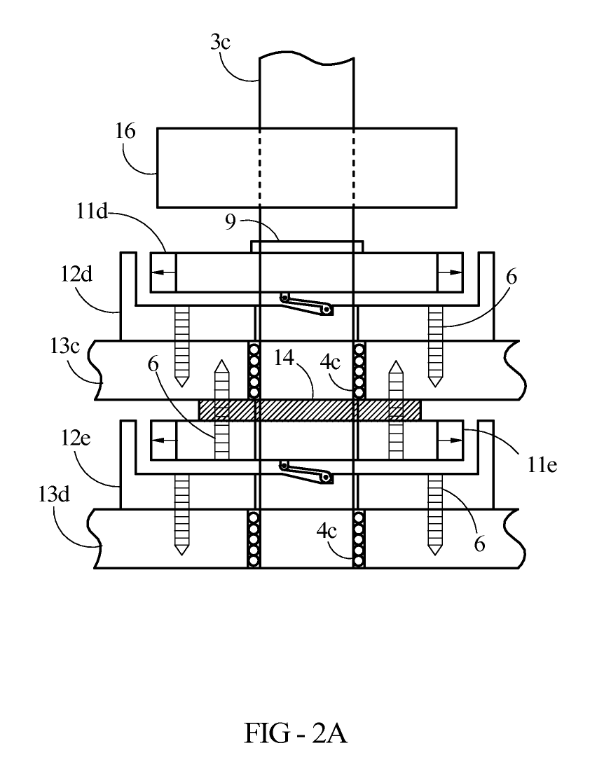

Optionally in FIG. 1A the gearbox 10, in addition to increasing rotational speed, changes the rotating shaft 3a from a horizontal shaft into a vertical shaft 3b. Optionally in FIG. 1B both shafts 3a and 3b would be vertical as in a typical Vertical Axis Wind Turbine (VAWT). For both of these options FIG. 2A would show the continuation of the sequencing.

In FIG. 2 (optionally FIG. 2A for the VAWT) shaft 3c passes through the generator 16 allowing the rotational energy to be converted into electricity. At a desired rotational speed, usually once the generator 16 exceeds rated speed, the inside expanding part 11d of the PLRS/Clutch assembly engages with the external part 12d of the PLRS/Clutch assembly which is fastened to flywheel 13c with fasteners 6 but not attached to shaft 3c. The flywheel 13c rotates freely around shaft 3c on bearing 4c. Additional PLRS/Clutch and flywheel assemblies are similarly configured to accommodate the desired number of flywheels for the specific application.

This configuration allows shaft 3c to spin freely within a series (multi-stack) of a desired number of flywheel assemblies without causing any of the flywheels to rotate. Once the output shaft 3c from the generator reaches a desired speed, this design initiates the first flywheel 13c behind the generator to begin rotating. Once flywheel 13c reaches a desired rotational speed, this design activates the next flywheel 13d and so on thereby storing the excess wind energy in a series of flywheels activated sequentially vs. all at the same time. In a preferred embodiment, all of the flywheels would be Variable Inertial Flywheels as described in U.S. patent application Ser. No. 11/833,611.

What is claimed is:

1. A flywheel system incorporated within a wind powered turbine comprising:
a plurality of flywheels;
a plurality of one-way ratchets or positive locking roller stops; and
a plurality of speed activated clutches.

2. The flywheel system of claim 1 wherein variable inertia flywheels as described in patent application Ser. No. 11/833,611 are used.

3. The flywheel system of claim 1 wherein a combination of the specified components are utilized between the turbines' rotor and generator.

4. The flywheel system of claim 1 wherein a combination of the specified components are utilized after the turbines' generator.

5. A means to increase electrical output of a wind turbine by lowering the required cut-in speed, compared to conventional technology.

6. A means to increase electrical output of a wind turbine by attaining rated speed into the generator earlier and with lower wind speeds than conventional technology.

7. A means to increase electrical output of a wind turbine by storing kinetic energy in a plurality of flywheels and releasing that stored energy back into the turbine system as required.

8. A method of arranging a plurality of flywheels, ratchets or positive locking roller stops and speed activated clutches to lower cut-in speeds and attain rated speeds earlier for a wind turbine.

9. A method of arranging a plurality of flywheels, ratchets or positive locking roller stops and speed activated clutches to store energy during the duration of the wind cycle and release the stored energy back into the turbine system as the wind subsides.
